(19) United States
(12) Patent Application Publication
(10) Pub. No.: US 2006/0190993 A1
(43) Pub. Date: Aug. 24, 2006

(54) Intrusion detection in networks

(75) Inventor: Gayle L. Noble, Boulder Creek, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 11/346,951

(22) Filed: Feb. 3, 2006

Related U.S. Application Data
(60) Provisional application No. 60/650,804, filed on Feb. 8, 2005.

(51) Int. Cl. H04L 9/32; G06F 12/14; G06F 15/173

(52) U.S. Cl. 726/3; 726/23; 726/27; 709/223

(57) ABSTRACT

Detecting network intrusions and tracking the network intruder. An attempt to access data without authorization is detected. The response to the unauthorized access is altered on the fly to include data that has been prepared for intruders. If the altered data is stored on an intermediary computer, the altered data may also include a script that notifies the network when the intruder accesses the altered data on the intermediary computer. Alternatively, the intruder can be tracked when the intruder attempts to access the data prepared for the intruder. In both cases the intruder can then be tracked to a more reliable IP address associated with the intruder.

### CROSS-REFERENCE TO RELATED APPLICATIONS

This application claims the benefit of U.S. Provisional Patent Application No. 60/650,804 filed on Feb. 8, 2005, entitled “INTRUSION DETECTION IN NETWORKS”, the contents of which are hereby incorporated by reference herein.

### BACKGROUND

1. The Field of the Invention

The present invention relates to systems and methods for network monitoring. More particularly, embodiments of the invention relate to systems and methods for detecting intrusions in networks.

2. The Relevant Technology

Computers and computer networks have become a necessity in both personal and business contexts. Information of all types can be found on computer networks and on the Internet. Both businesses and individuals are conducting more transactions online. The ability, for example, to shop, bank, and communicate online have proved to be convenient, easy, and successful. Unfortunately, there is another aspect of online activity that has developed just as fast. Fraud, identify theft, and the like are serious problems that must be addressed on a daily basis. Most computer users are aware of the need for security software to protect themselves from viruses, worms, and Trojan horses. In fact, various websites and software suites are specifically devoted to providing protection from these types of security threats.

Another aspect of network security relates to attempts to access data illegally or without authorization. For example, databases and other data storage configurations are under attack from hackers. This information stored in these databases may be, by way of example, financial information, industrial trade secrets, classified government data, and the like. Because attempts are made to gain unauthorized access to information, there is a serious need to detect such intrusions.

Intrusion detection should be an integral part of network security because of the difficulty in staying up to date with existing and potential threats as well as the vulnerabilities of computer systems and networks. As new technology is developed, and new security flaws are discovered in existing software and systems, there is an ever present need to detect unauthorized intrusions. In fact, the danger from hackers is always present because new technologies, new products, software updates, and the like, each typically have unintended flaws and vulnerabilities. Further, new flaws and vulnerabilities for existing products are often discovered first by hackers.

If an intrusion is not detected, then the potential for loss can be significant. For example, an intrusion can bring a network down and result in lost time. An intrusion can lead to the theft or destruction of confidential information. Intrusions can be the means for stealing assets and compromising security in many ways. In other words, the potential for harm is great.

Intrusion detection products can assist in the protection of a network from the dangers of unauthorized access. These tools can be used to detect, identify, and stop an intruder as well as help prevent the network from being similarly exploited in the future. Although there are intrusion detection tools that can help prevent intrusions, it is still difficult to track and identify the actual intruder attempting the unauthorized access. This often relates to the fact that the hackers hide their identity in multiple ways. Hackers or other intruders, for example, forge headers, work through intermediary computers or unknowing servers, and the like. Because the hackers obscure their tracks as well as their identify, simply detecting the intrusion is often insufficient to identify the hacker.

### BRIEF SUMMARY OF SEVERAL EXAMPLE EMBODIMENTS

A method for tracking an intruder that attempts to access a network without authorization is disclosed. The method includes detecting an intrusion by an intruder, wherein the intrusion includes a request for access to requested data. The method further includes altering the requested data to create altered data. The method further includes sending the altered data to be accessed by the intruder.

A network analysis apparatus for detecting intrusion within a network is disclosed. The network analysis apparatus includes a data processing device coupled to the network and configured to receive data transmitted in the network. The data processing device includes a computer readable medium having computer-executable instructions for receiving data transmitted in the network, detecting an unauthorized request for data by an intruder, creating altered data in response to the request, and sending the altered data to be accessed by the intruder.

A method for tracking an intruder who attempts to obtain unauthorized access to data in a network is disclosed. The method includes performing the act of receiving a request from a unauthorized intruder for data stored in the network at an intermediary computer coupled to a network. The method further includes transmitting the request for the data stored in the network to the network at the intermediary computer coupled to a network. The method further includes receiving altered data from the network at the intermediary computer coupled to a network, the altered data not representing the requested data. The method further includes receiving a script along with the altered data at the intermediary computer coupled to a network. The method further includes executing the script at the intermediary computer coupled to a network. The method further includes tracking the unauthorized intruder at the intermediary computer coupled to a network when the unauthorized intruder attempts to access the altered data.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary environment for implementing embodiments of the invention;

FIG. 2 illustrates one embodiment of a system for identifying an intruder that intrudes a network; and

FIG. 3 illustrates one embodiment of a method for identifying a network intruder.

### DETAILED DESCRIPTION OF SEVERAL EMBODIMENTS

The principles of the embodiments described herein describe the structure and operation of several examples used to illustrate the present invention. It should be understood that the drawings are diagrammatic and schematic representations of such example embodiments and, accordingly, are not limiting of the scope of the present invention, nor are the drawings necessarily drawn to scale. Well known devices and processes have been excluded so as not to obscure the discussion in details that would be known to one of ordinary skill in the art.

Intrusion detection typically relates to attempts to monitor and analyze system events in order to detect and prevent unauthorized access to system resources or data. Intrusion detection can be performed using a variety of different manners that include, but are not limited to, a review of network logs, statistical analysis of network traffic, capturing and analyzing network traffic in real time or near real time, and the like or any combination thereof.

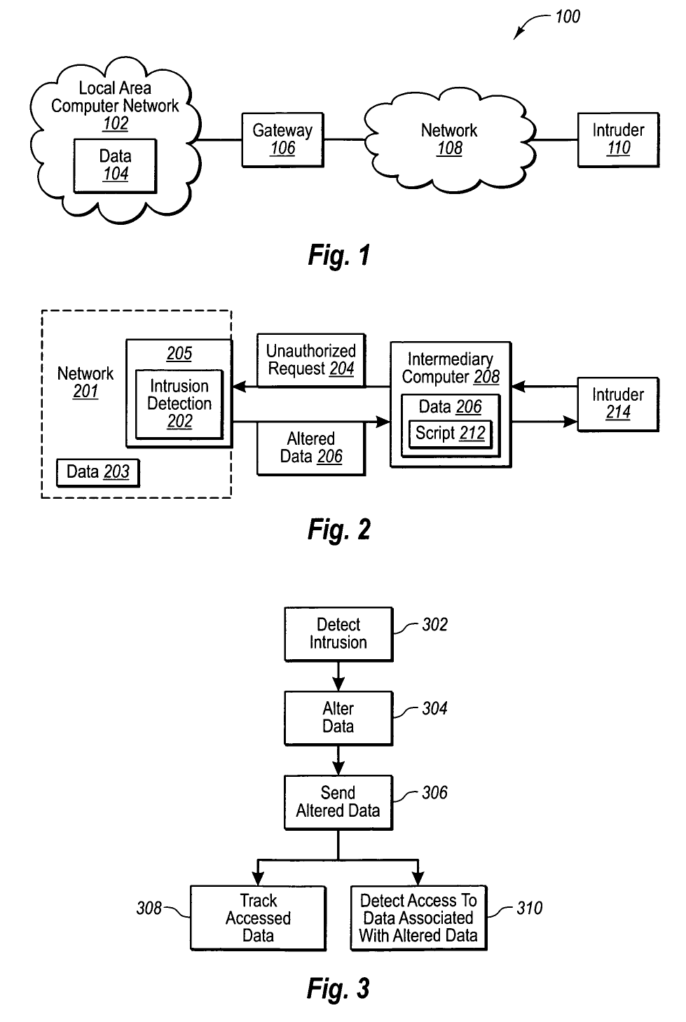

Embodiments of the invention are directed to systems and methods for detecting unauthorized access as well as intrusions. Embodiments of the invention further relate to identifying the intruder or to obtaining more information related to the intruder. FIG. 1 illustrates an exemplary environment for implementing embodiments of the invention.

FIG. 1 illustrates a local area network (LAN) 102. The LAN 102 is typically associated with data 104. The data 104 is representative of information that is protected. The data 104 can be of any nature including, but not limited to, confidential data, financial data, trade secrets, personal information, and the like. Usually, the data 104 can only be accessed by all or some of the authorized users of the LAN 102.

For example, the LAN 102 may be the local network of a business entity such as a bank. The data 104 can correspond to account data of the bank's customers. Only users authorized by the bank should have access to the data 104.

The LAN 102, however, may also be connected to another network 108 such as the Internet or other wide area network through a server computer represented by the gateway 106. In this example, data passing to and from the LAN 102 passes through the gateway 106. In this example, an intruder 110, such as a hacker, is typically connected with the network 108 and usually attempts to access the data 104 of the LAN 102 through the gateway 106. In this example, the intruder 110 represents a computer, server, or network or computers/servers, that is used by an unauthorized person or entity who is trying to gain unauthorized access to the data 104.

Because of the potential for the intruder 110 to access the data 104 without authorization, the gateway 106 is typically equipped to perform network intrusion detection. The gateway 106 may accomplish intrusion detection using, for example, a network analyzer that includes a network processor such as, by way of example and not limitation, an NP-1c Network Processor available from EZchip Technologies Inc. The network analyzer detects an intrusion and then responds accordingly to prevent unauthorized access to the data 104.

FIG. 2 is a block diagram of one example of a network intrusion. When an intruder attempts to access data or a network without authorization, the intruder often takes precautions to hide their actual identify. This can include forging headers, as well as operating through other computers or servers. In this example, the intruder 214 is operating through at least one intermediary computer 208. The intruder 214, for example, may have compromised the intermediary computer 208 such that the intermediary computer 208 is unaware that it is being used by the intruder 214.

Through the intermediary computer 208, the intruder 214 initiates an unauthorized request 204 for access to data in the network 201. In this example, the network 201 includes a network analyzer 205 that provides intrusion detection 202 that detects the unauthorized request 204. The intrusion is detected, for example, by analyzing the network traffic. The network analyzer can identify an unusual pattern in routing headers, for example, that may suggest an unauthorized access attempt. One of skill in the art can appreciate that embodiments of the invention can be used with existing intrusion detection techniques as well as with additional intrusion detection techniques as they become available.

The network analyzer 205 can also be a diagnostic tool that performs analysis of the network 201 other than searching for network intrusion. For example, the analysis can include detection of errors in the transmitted data or diagnoses performance and reliability issues with the network 201. The errors can be introduced by software or hardware introduced at the source of the data transmission or at any point in the network as the data is transmitted from source to destination. The network analyzer 205 can simultaneously analyze data for protocol errors in addition to intrusion. The network analyzer 205 can also monitor, diagnose and prevent performance problems within the network. The network analyzer 205 can include software for increasing performance and reliability and minimizing downtime of the network.

In this example, the intrusion detection 202 of the network 201 detects the unauthorized request 204 from the intruder 214. The network analyzer 205, which may be a network diagnostic module, of the network 201 sends back altered data 206 to the intermediary computer 208. In other words, the intrusion detection 202 capabilities can detect the unauthorized request 204 on the fly, and then generate altered data 206 in response. As a result, the data 203 of the network 201 is not accessed. At the same time, the intruder 214 believes that unauthorized access has been achieved into the network 201 and/or to the data 203.

The altered data 206 is then stored on the intermediary computer 208. The altered data 206 can, in some embodiments, include a script 212 that the intruder 214 is unaware of. When the intruder 214 attempts to retrieve the altered data 206 from the intermediary computer 208, the script 212 is activated and the network 201 is notified that the altered data 206 is being accessed. The network 201 or other entity can then trace the altered data 206 accessed by the intruder 214 in an attempt to more accurately identify the intruder 214. This can be done with or without the consent of the intermediary computer 208.

In another embodiment, the altered data 206 may include data that references a special account on the network data 203. When an attempt to access the special account in the network data 203 is made, the network 201 or other entity can then know that the access is likely being made by the intruder 214.

For example, assume that the intrusion was directed to an account owned by John Jones. Specifically, the intrusion attempted to gain access to the account number and the password of John Jones. The network processor can change the account number on the fly to a special account number that is returned in the altered data. The network then assigns the password sent to the intruder to the special account number included in the altered data. The network also changes the name of the special account to John Jones. The intruder then attempts to access the special account and can be tracked accordingly.

As previously indicated, some intruders do not have the data sent to themselves directly. They use an intermediary computer where the intruder has established some type of account that the intruder can access. Even though the network 201 knows where the altered data 206 is sent, this may not be enough to identify the intruder because the intermediary computer 208 the intruder is using is not necessarily associated with the intruder. In other words, the intruder may have set up an unauthorized account on the intermediary computer 208 itself. Often, the intermediary computer is unaware of the unauthorized account.

The intruder can be identified when any attempt to access the special account is made. The attempt to access the special account can be traced back to the real internet protocol (“IP”) address of the intruder or to a real IP address that is associated with the intruder. Alternatively, the altered data can also include a script that may be used to track the intruder when the stolen data is accessed by the intruder from the intermediary computer.

The script can be a set of executable instructions, such as software, that is sent along with the altered data to the intermediary computer. When executed, the script can gather information describing the intruder. For example, the script can gather information describing the IP address of the intruder, email address and accounts associated with the intruder, email accounts and addresses associated with recipients of emails sent from the intruder's IP address, the internet service provider (“ISP”) providing internet service to the intruder, user names and passwords transmitted over the internet by the intruder, or any other information that may be intercepted as it is transmitted by the intruder over the Internet.

FIG. 3 illustrates an exemplary method for detecting a network intrusion and more particularly to a method for tracking or identifying the intruder. In one embodiment, at least a more reliable IP address associated with the intruder can be identified. Other information can be collected about the intruder as well. With an IP address, the network the intruder or hacker is on can be identified as well as their service provider. With this information, the intruder can be monitored and locations that the intruder visits or accesses can be monitored. The IP addresses to which the intruder sends mail can also be tracked. These IP addresses can also be monitored if necessary.

In this example, a network has a computer device that may include a network processor or network analyzer that detects an intrusion 302. As the intrusion is detected, the network processor alters the data on the fly 304. The data can be altered, for example, by substituting a special account number for the requested account number. Alternatively, the data can be altered by changing a location of the data the intruder is attempting to access to correspond to data that has been prepared for an intruder.

The network processor then sends the altered data 306 to the intruder. As previously indicated, an intruder typically operates through at least one intermediary computer. The altered data may include a script that notifies the network when the intruder accesses the altered data from the intermediary computer. For example, the script can inform the monitoring network that the altered data has been accessed and by what IP to the extent that the IP of the intruder is not masked. IPs can be masked such that the routing information may not be available. However, to get data there must be a return IP address and a script can log this information and send it to the monitoring network. The script can send the date, time, what was requested and where it was sent. If the script was running with the permission of the person who owned the intermediate computer, then the script could also report anything else on the intermediate computer that was accessed without authorization.

The script can be adapted to perform other functions as well. In other words, the network can track the altered data when accessed from the intermediary computer 308 to identify a more reliable IP address of the intruder. Alternatively, the network can wait to detect access 310 to the specially prepared data associated with the altered data.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A method for tracking an intruder that attempts to access a network without authorization, the method comprising:
detecting an intrusion by an intruder, wherein the intrusion includes a request for access to requested data;
altering the requested data to create altered data; and
sending the altered data to be accessed by the intruder.

2. A method according to claim 1, further comprising:
receiving information describing the intruder when the intruder attempts to access the altered data; and
identifying the intruder based on the information describing the intruder.

3. A method according to claim 1, wherein altering the requested data includes substituting a special account number for the requested account number or changing a location of the requested data the intruder is attempting to access to correspond to the altered data that has been prepared for the intruder.

4. A method according to claim 1, further comprising sending a script along with the altered data to an intermediary computer, when the script is configured to retrieve information describing the intruder.

5. A method according to claim 1, further comprising first receiving data transmitted in the network.

6. A method according to claim 1, further comprising identifying the user by at least one of an internet protocol address from which the intruder is accessing the altered data, information contained in an email sent or received by the intruder, internet protocol addresses visited by the intruder, or an internet provider used by the intruder.

7. A method according to claim 2, wherein receiving information describing the intruder when the intruder attempts to access the altered data further comprises identifying an internet protocol address of the intruder when the intruder accesses the altered data from an intermediary computer using a script that was transmitted with the altered data.

8. A method according to claim 1, wherein detecting the intrusion includes identifying an unauthorized request for at least one of financial data, user name data, password data, personal information, trade secret information, or classified information.

9. A method according to claim 1, wherein detecting the intrusion includes detection of a pattern in routing headers that suggests an unauthorized access attempt.

10. A method according to claim 1, further comprising:
performing network analysis of the data received.

11. A method according to claim 10, wherein the network analysis includes at least one of analysis of the network for errors in the data transmitted in the network, analysis of a performance of the network, or analysis for recognition of a type of data transmitted by the network.

12. A method according to claim 1, wherein the intruder detection is performed at a substantially real-time rate as the data is transmitted in the network.

13. A network analysis apparatus for detecting intrusion within a network, the network analysis apparatus comprising:
a data processing device coupled to the network and configured to receive data transmitted in the network, wherein the data processing device includes a computer readable medium having computer-executable instructions for:
receiving data transmitted in the network;
detecting an unauthorized request for data by an intruder;
creating altered data in response to the request; and
sending the altered data to be accessed by the intruder.

14. A network analysis apparatus according to claim 13, further comprising computer executable instructions for:
sending a script along with the altered data, the script including computer executable instructions that when executed collect information describing the intruder.

15. A network analysis apparatus according to claim 14, wherein the script and data are sent to an intermediary computer for execution of the script at the intermediary computer, and for allowing access to the altered data by the intruder at the intermediary computer.

16. A network analysis apparatus according to claim 14, wherein the script is configured to collect the information describing the intruder and further configured to send the collected information to the network analysis apparatus.

17. A network analysis apparatus according to claim 14, wherein the information describing the user includes at least one of an internet protocol address of the intruder, an internet service provider of the intruder, a recipient of an email sent by the intruder, an internet protocol address visited by the intruder, or an email address of an email sent from the internet protocol address of the intruder.

18. A network analysis apparatus according to claim 13, wherein the data requested by the intruder is at least one of financial data, user name data, password data, personal information, trade secret information, or classified information.

19. A network analysis apparatus according to claim 13, wherein detecting the unauthorized request includes identifying an unauthorized request for at least one of financial data, user name data, password data, personal information, trade secret information, or classified information.

20. A network analysis apparatus according to claim 13, further comprising:
performing network analysis of the data received.

21. A network analysis apparatus according to claim 20, wherein the network analysis includes at least one of analysis of the network for errors in the data transmitted in the network, analysis of a performance of the network, or analysis for recognition of a type of data transmitted by the network.

22. A method for tracking an intruder who attempts to obtain unauthorized access to data in a network, comprising:
at an intermediary computer coupled to a network, performing the following acts:
receiving a request from a unauthorized intruder for data stored in the network;
transmitting the request for the data stored in the network to the network;
receiving altered data from the network, the altered data not representing the requested data;
receiving a script along with the altered data;
executing the script; and
tracking the unauthorized intruder when the unauthorized intruder attempts to access the altered data.

23. A method according to claim 22, wherein tracking the unauthorized intruder includes gathering information describing the unauthorized intruder, the information gathered describing at least one of an internet protocol address of the user, an email address of the intruder, an email address of a recipient of an email sent by the intruder, or an internet service provider associated with the unauthorized intruder, the method further comprising transmitting the information describing the unauthorized intruder to the network.
